(19) United States
(12) Patent Application Publication
(10) Pub. No.: US 2014/0373031 A1
(43) Pub. Date: Dec. 18, 2014

(54) Method, Device and Computer Program For Visualizing Risk Assessment Values in Event Sequences

(71) Applicant: INTERNATIONAL BUSINESS MACHINES CORPORATION, Armonk, NY (US)

(72) Inventors: Tsuyoshi Ide, Kanagawa-ken (JP); Raymond Harry Rudy, Kanagawa-ken (JP)

(21) Appl. No.: 14/362,614

(22) PCT Filed: Nov. 29, 2012
(86) PCT No.: PCT/JP2012/080880

§ 371 Date: Jun. 4, 2014

(30) Foreign Application Priority Data
Dec. 6, 2011 (JP) 2011-266666

(51) Int. Cl. G06F 9/54

(52) U.S. Cl. CPC G06F 9/542
USPC 719/318

(57) ABSTRACT

The present invention provides a method, system and computer program in which risk assessment values are calculated and displayed for event sequences, in which the event sequences consist of events of a finite number M of types and in which some of the event group is a partially ordered set in a time series. An M-dimensional sparsely ordered matrix is generated on the basis of an event sequence, interpolation is performed between the elements of the generated sparsely ordered matrix, and a densely ordered matrix is calculated. A mapping matrix is calculated for mapping the similarity relations between event sequences in two-dimensional space or three-dimensional space based on the calculated densely ordered matrix, the corresponding points of each event sequence are calculated in two-dimensional space or three-dimensional space using the calculated mapping matrix, and the calculated corresponding points are outputted and displayed in two-dimensional or three-dimensional space.

### CROSS-REFERENCE TO RELATED APPLICATION

This application claims priority under 35 U.S.C. 371 from PCT Application, PCT/JP2012/080880, filed on Nov. 29, 2012, which claims priority from the Japanese Patent Application No. 2011-266666, filed on Dec. 6, 2011. The entire contents of both applications are incorporated herein by reference.

### BACKGROUND OF THE INVENTION

1. Field of the Invention

The present invention relates to a method, device and computer program for visualizing calculated risk assessment values in which risk assessment values for the occurrence of a predetermined event are calculated for each event sequence partially occurring in a time series.

2. Description of the Related Art

Often, before a critical event occurs, a number of events considered to be harbingers occur in a time series. Therefore, it is desirable to estimate the possibility of a critical event occurring from a group of events occurring in a time series (referred to below as an event sequence) in order to provide advance warning.

However, in many situations, it is often unclear from a given event sequence about which event is linked to a critical event. Also, it is difficult to assume the link among events beforehand in a given situation because the number of possible event sequences is often huge. Therefore, various systems have been developed to predict the occurrence of events by estimating risk assessment values modeled from, for example, neuron models and case-based inference engines.

For example, an information management device is described in Laid-open Patent Publication No. JP 2002-207755 that describes a case-based inference engine. In JP 2002-207755, in order to consider the time series in cases, time series data is inputted and stored. The importance of these cases is calculated, and cases with a high degree of importance are extracted as similar cases.

However, even when time series data is used as the input, the prior art: Laid-open Patent Publication No. JP 2002-20775, only calculates a degree of importance that takes into account the season, the time period, etc. For example, even when the same type of events has occurred in the same time period, the events that can occur are different if the time series are different. Thus, it is difficult to correctly extract similar events.

Also, it is impossible to realistically assume all possible cases in a medical event. Even if they can be assumed, very few cases are completely the same. Therefore, it is not realistic to store all cases beforehand as similar cases for extraction. In other words, a suitable means does not exist for comparing event sequences with different lengths and elements, and it is difficult to visually verify and to give feedback on risk assessment values based on event sequences.

In view of this situation, the purpose of the present invention is to provide a method, device and computer program for visualizing risk assessment values for event sequences in which totally ordered sets can be estimated on the basis of partially ordered sets indicating an event sequence, and the risk assessment values calculated for each event sequence can be visualized.

### SUMMARY OF THE INVENTION

One aspect of the present invention provides a method for calculating and displaying a plurality of risk assessment values for an event sequence, wherein the event sequence comprises a plurality events for a finite number M of types (where M is a natural number) and a portion of the event group being a partially ordered set in a time series. The method includes: generating an M-dimensional sparsely ordered matrix based on the event sequence, and interpolating between a plurality of elements of the M-dimensional sparsely ordered matrix to calculate a densely ordered matrix; calculating a mapping matrix for mapping a plurality of similarity relations between a plurality of event sequences in two-dimensional space or three-dimensional space based on the densely ordered matrix; calculating the plurality of corresponding points of each event sequence in two-dimensional space or three-dimensional space using the mapping matrix; and outputting and displaying the plurality of corresponding points in two-dimensional or three-dimensional space

Another aspect of the present invention provides a device for calculating and displaying a plurality of risk assessment values for an event sequence, wherein the event sequence includes a plurality of events for a finite number M of types (where M is a natural number) and a portion of the event group being a partially ordered set in a time series, the device comprising: an order matrix calculating means for generating an M-dimensional sparsely ordered matrix on the basis of the event sequence, and interpolating between a plurality of elements of the M-dimensional sparsely ordered matrix to calculate a densely ordered matrix; a mapping matrix calculating means for calculating a mapping matrix for mapping a plurality of similarity relations between a plurality of event sequences in two-dimensional space or three-dimensional space based on the densely ordered matrix; and a display output means for calculating a plurality of corresponding points of each event sequence in two-dimensional space or three-dimensional space using the mapping matrix; and outputting and displaying the plurality of corresponding points in two-dimensional or three-dimensional space.

Another aspect of the present invention provides A computer readable non-transitory article of manufacture tangibly embodying computer readable instructions which, when executed, cause a computer to calculate and display a plurality of risk assessment values for an event sequence, wherein the event sequence includes a plurality of events for a finite number M of types (where M is a natural number) and a portion of the event group being a partially ordered set in a time series, the computer program which executes the method explained above.

### BRIEF DESCRIPTION OF THE DRAWINGS

FIG. 1 is a block diagram schematically illustrating the configuration of the risk assessment value display device in an embodiment of the present invention.

FIG. 2 is a functional block diagram of the risk assessment value display device in an embodiment of the present invention.

FIG. 3 is a diagram illustrating an event sequence acquired by the risk assessment value display device in an embodiment of the present invention.

FIG. 4 is a diagram illustrating a similarity matrix in which the degree of similarity between events is represented.

FIG. 5 is a diagram illustrating a partially ordered matrix generated by the risk assessment value display device in an embodiment of the present invention.

FIG. 6 is a diagram illustrating an example in which an acquired coordinate value is outputted and displayed in two-dimensional space.

FIG. 7 is a diagram illustrating an example in which circumscribed areas are superimposed, outputted and displayed in two-dimensional space.

FIG. 8 is a flowchart showing the processing steps performed by the CPU of the risk assessment value display device in an embodiment of the present invention.

### DETAILED DESCRIPTION OF THE PREFERRED EMBODIMENTS

The following is a detailed description with reference to the drawings of a risk assessment value display device in an embodiment of the present invention. This device calculates risk assessment values related to the occurrence of a predetermined event in each event sequence in which a portion of the event group indicates a time series, and then visualizes the calculated risk assessment values. Needless to say, this embodiment does not limit in any way the present invention as described in the scope of the claims, and all combinations of features explained in the embodiment are not necessarily essential to the technical solution of the present invention.

Also, the present invention can be embodied many different ways, and should not be interpreted as being limited to the description of the embodiment. Throughout the embodiment, the same elements are denoted by the same reference signs.

In the following embodiment, a device is explained in which a computer program has been introduced to a computer system. However, as should be clear to any person skilled in the art, the present invention can be embodied as a computer program that can execute a portion of this using a computer. Thus, the present invention can be embodied as hardware such as a risk assessment value display device which calculates risk assessment values for the occurrence of a predetermined event for each event sequence partially occurring in a time series and visualizes the calculated risk assessment values, as software, or as a combination of software and hardware. The computer program can be recorded on any computer-readable recording medium such as a hard disk, a DVD, a CD, an optical storage device, or a magnetic storage device.

In the embodiment of the present invention, risk assessment values can be calculated for each event sequence by converting partially ordered sets (matrices) indicating event sequences with different lengths and elements into totally ordered sets (matrices), and past cases can be easily compared by displaying and outputting the calculated risk assessment values in two-dimensional space or three-dimensional space. Also, the possibility (risk) of a critical event occurring can be visually evaluated in each event sequence by plotting and displaying or by performing a density conversion and then displaying the calculated risk assessment values in two-dimensional or three-dimensional space.

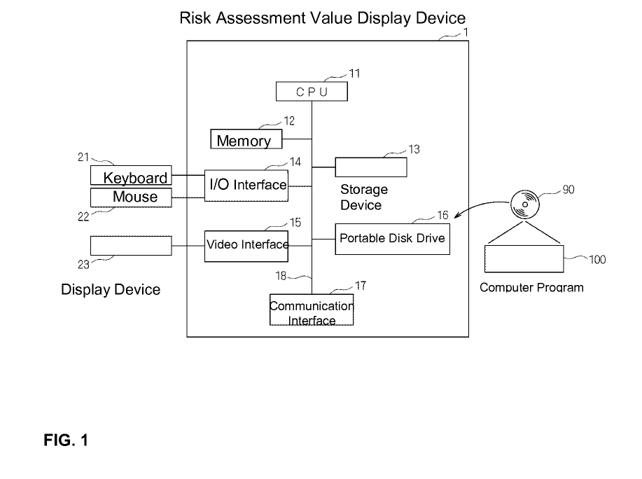

FIG. 1 is a block diagram schematically illustrating the configuration of the risk assessment value display device in an embodiment of the present invention. The risk assessment value display device 1 in the embodiment of the present invention includes at least a central processing unit (CPU) 11, memory 12, a storage device 13, an I/O interface 14, a video interface 15, a portable disk drive 16, a communication interface 17, and an internal bus 18 connected to the hardware described above.

The CPU 11 is connected via the internal bus 18 to each unit of hardware in the risk assessment value display device 1 described above, controls the operations performed by each unit of hardware described above, and executes various software functions according to the computer program 100 stored in the storage device 13. The memory 12 is volatile memory such as SRAM or SDRAM, which expands load modules during execution of the computer program 100, and temporarily stores data generated during the execution of the computer program 100.

The storage device 13 can be a built-in fixed storage device (hard disk) and ROM. The computer program 100 stored in the storage device 13 is downloaded using a portable disk drive 16 from a portable recording medium 90 such as a DVD or CD-ROM on which the program and information such as data have been recorded. During execution, the program is expanded from the storage drive 13 to the memory 12 and executed. Of course, the computer program can also be downloaded from an outside computer connected via the communication interface 17.

The communication interface 17 is connected to the internal bus 18 and connected, in turn, to an outside network such as the Internet, a LAN or a WAN in order to be able to exchange data with an outside computer.

The I/O interface 14 is connected to input devices such as a keyboard 21 and a mouse 22 to receive data inputs. The video interface 15 is connected to a display device 23 such as a CRT display or a liquid crystal display to display on the display device 23 risk assessment values calculated for sampled event sequences and risk assessment values calculated for event sequences sampled in the past.

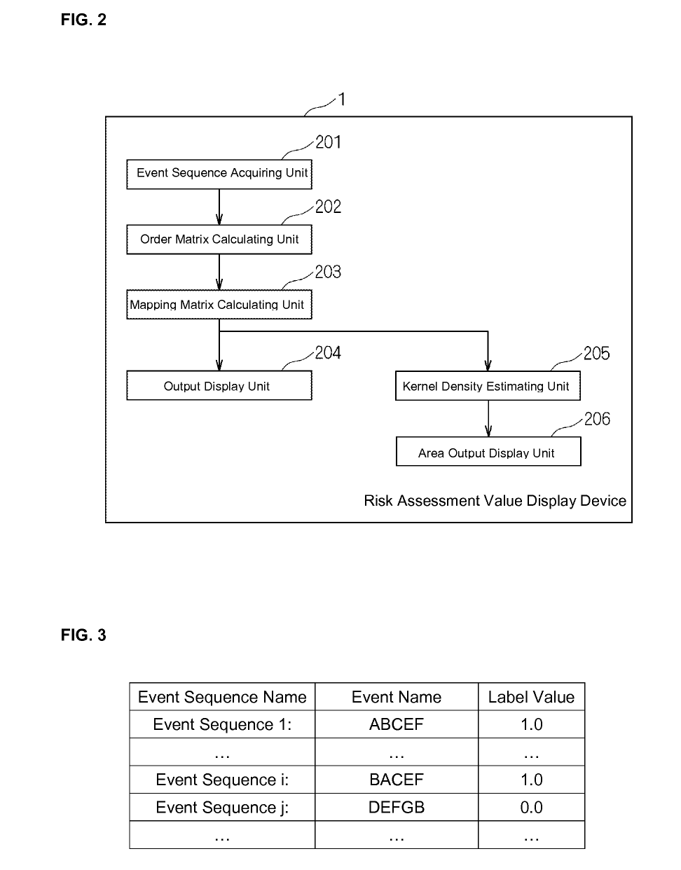

FIG. 2 is a functional block diagram of the risk assessment value display device 1 in the embodiment of the present invention. In FIG. 2, the event sequence acquiring unit 201 of the risk assessment value display device 1 acquires as sampling data event sequences in the form of time series data for a plurality of events. More specifically, a finite number N of event sequences (where N is a natural number), risk values for each event sequence, and the degree of similarity between elements included in each event sequence are acquired.

FIG. 3 is a diagram illustrating an event sequence acquired by the risk assessment value display device 1 in the embodiment of the present invention. In the example shown in FIG. 3, the event sequences with a finite number M of types of events (where M is a natural number) are represented as event sequences 1, 2, . . . , i, j, . . . , N. In event sequence 1, events A, B, C, E and F represent events that have occurred. Also, “1.0” and “0.0” in the right-hand column are label values indicating whether or not a risk has occurred. In each event sequence, label value “1.0” indicates that a risk has occurred, and “0.0” indicate that a risk has not occurred.

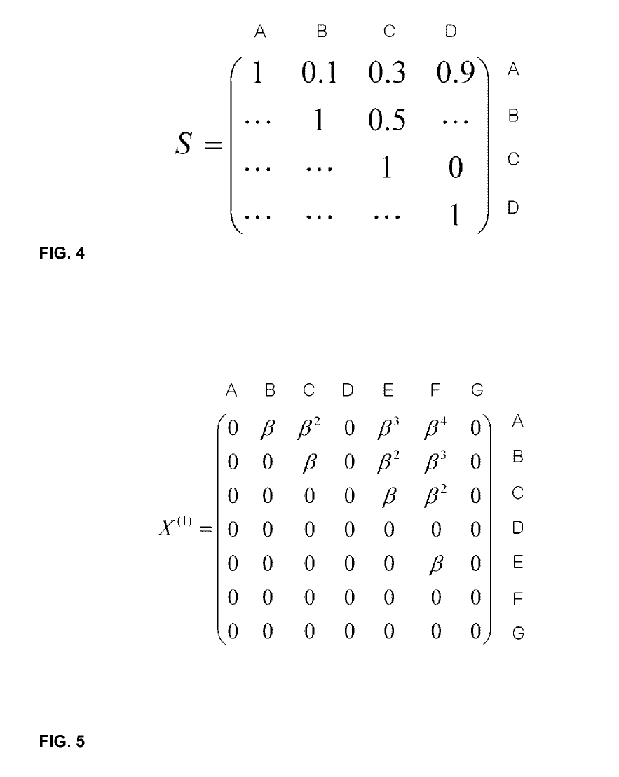

FIG. 4 is a diagram illustrating a similarity matrix S in which the degree of similarity between events is represented. For example, the degree of similarity between event i and event j can be represented by Sij in the i-th row and the j-th column of the similarity matrix S. The degree of similarity for identical events is represented by “1”. This is represented below as a similarity matrix in which the values approach “1” as the degree of similarity increases.

The event sequences can be acquired from an outside computer connected via the communication interface 17, or can be acquired from a portable recording medium 90 such as a DVD or CD-ROM using a portable disk drive 16. They can also be acquired by receiving direct input via input devices such as a keyboard 21 and mouse 22.

Returning to FIG. 2, the order matrix calculating unit 202 generates M-dimensional partially ordered matrices (partially ordered sets) representing the order of events based on acquired event sequences, and converts the generated partially ordered matrices into an approximation of totally ordered matrices (totally ordered sets). In other words, because the partially ordered matrices generated on the basis of acquired event sequences are sparsely ordered matrices (so-called sparse matrices) in which most of the elements are “0”, they are converted to totally ordered matrices by interpolating the elements of sparse matrices whose values are “0”.

FIG. 5 is a diagram illustrating a partially ordered matrix generated by the risk assessment value display device 1 in the embodiment of the present invention. In FIG. 5, X⁽¹⁾ is the partially ordered matrix of event sequence 1 in FIG. 3, and the event sequence X⁽¹⁾ is represented here on the assumption that there are seven types of event sequences A-G.

As shown in FIG. 5, the lines correspond to events A, B, . . . , G from the top, and the columns correspond to A, B, . . . , G from the left. β is a default value that is less than 1, and becomes a value corresponding to the interval between each event.

For example, since events occur as events A, B, C, E, F in event sequence 1 as shown in FIG. 3, the elements are determined as viewed from event A (first line) so that event B is β because of an interval of “1”, event C is “β²” because of an interval of “2”, and event D is “0” because there is none.

In other words, element X⁽ⁱ⁾ (e1, e2) in partially ordered matrix X⁽ⁱ⁾ of event sequence i can be determined by (Equation 1). In (Equation 1), function I (e1, e2) returns “1” when event e1 is prior to event e2. Otherwise, it returns “0”. Also, s indicates the number of hops between event e1 and event e2 (a value proportional to the interval between the two). For example, the number of hops s from event A to event B is “1”, and the number of hops s from event A to event C is “2”. Therefore, a partially ordered matrix can be generated in which the elements have smaller values as the distance between events increases.

Equation 1

X⁽ⁱ⁾_{e1,e2}=I(e1,e2)β^{s} (Equation 1)

A partially ordered matrix X is generated for each event sequence on the basis of (Equation 1), but the generated partially ordered matrices X are sparsely ordered matrices in which most of the elements are “0”. Therefore, the generated partially ordered matrices are interpolated using the so-called label propagation method. In other words, a densely ordered matrix U is calculated by properly interpolating areas of the partially ordered matrix X in which the elements are “0” in accordance with (Equation 2) so that the difference between elements is smaller than in the original partially ordered matrix X, and so that each element is weighted in accordance with the degree of similarity in the event sequence.

$$\begin{matrix} Equation 2 & \\ U = arg {min}_{\{ {U}^{( 1 )} , {U}^{( 2 )} , … , {U}^{( N )} \}} {\sum }_{k = 1}^{N} {‖ {X}^{( k )} - {U}^{( k )} ‖}_{2}^{2} + λ {\sum }_{k = 1}^{N} {\sum }_{i 1 , i 2 , j 1 , j 2}^{ } {{\tilde{S}}_{( i 1 , j 1 ) , ( i 2 , j 2 )} ( {U}_{( i 1 , j 1 )}^{( k )} - {U}_{( i 2 , j 2 )}^{( k )} )}^{2} & ( Equation 2 )\end{matrix}$$

Returning to FIG. 2, the mapping matrix calculating unit 203 maps the similarity relations between event sequences in two-dimensional space or three-dimensional space using an embedding method based on the calculated densely ordered matrix U. More specifically, the mapping matrix is calculated as a matrix which minimizes an objective function able to maintain a similarity relation equally between event sequences even when the similarity relation between event sequences has been mapped in two-dimensional or three-dimensional space.

In this embodiment, a calculated densely ordered matrix U⁽ⁱ⁾ (i=1−N) is converted to N column vectors u as shown in (Equation 3). For example, function vec for converting a 3×3 matrix into column vectors is defined as shown in (Equation 3).

$$\begin{matrix}Equation 3 & \\ vec ( ( \begin{matrix}a & b & c \\ d & e & f \\ g & h & i\end{matrix} ) ) = ( \begin{matrix}a \\ b \\ c \\ d \\ e \\ f \\ g \\ h \\ i\end{matrix} ) & ( Equation 3 )\end{matrix}$$

The mapping matrix A for mapping the space, for example, two-dimensional space or three-dimensional space, in which the N column vectors u are outputted and displayed is calculated on the basis of (Equation 4). In (Equation 4), z is, for example, a two-dimensional column vector consisting of (p, q) when two-dimensional space consisting of orthogonal axes p and q is mapped. Mapping matrix A is a (2×100) matrix when vector u is a column vector consisting of “100” elements.

Equation 4

z=Au (Equation 4)

Mapping vector A is calculated as a matrix in which the objective function shown in (Equation 5) is minimized.

$$\begin{matrix} Equation 5 & \\ Φ ( A ) = {\sum }_{n , {n}^{′} = 1}^{N} \{ {K}_{n , {n}^{′}} {‖ A ( {u}^{( n )} - {u}^{( {n}^{′} )} ) ‖}^{2} - μ {D}_{n , {n}^{′}} {‖ {Au}^{( n )} ‖}^{2} \} & ( Equation 5 )\end{matrix}$$

In (Equation 5), K_{n,n′} is a function indicating the degree of similarity between event sequences n and n′. This can be expressed using (Equation 6). D_{n,n′} is shown in (Equation 8) and described below.

$$\begin{matrix}Equation 6 & \\ {K}_{n , {n}^{′}} = exp ( - \frac{1}{2 {σ}^{2}} {‖ {u}^{( n )} - {u}^{( {n}^{′} )} ‖}^{2} ) & ( Equation 6 )\end{matrix}$$

In (Equation 5), the first term is the term adjusted to keep the degree of similarity between event sequences equal after they are mapped in a predetermined space such as a two-dimensional space or three-dimensional space, and the second term is the term for keeping the mapping range converged in a predetermined range.

In other words, the objective function shown in (Equation 5) is essentially equal to an objective function used in the method called Locality Preserving Projections (LPP). However, a conventional LPP objective function is not used to convert an event sequence into a vector, and does not function as an LPP objective function with a sparse matrix in which most of the elements are 0 (zero).

Therefore, in this embodiment, the mapping matrix A is calculated using an objective matrix after a densely ordered matrix U has been calculated. In other words, the mapping matrix A can be calculated as a solution to the generalized eigenvalue problem shown in (Equation 7).

Equation 7

Φ(A)=Tr(AUGU^{T}A^{T}−μAUDU^{T}A^{T}) (Equation 7)

However, G_{n,n′}≡δ_{n,n′}D_{n,n′}−K_{n,n′}

In (Equation 7), Tr is a function for calculating diagonal elements in the matrix, and returns a scalar value that is the sum of the diagonal elements. Also, D_{n,n′} can be expressed in (Equation 8) using Kronecker delta δ_{n,n′}.

$$\begin{matrix}Equation 8 & \\ {D}_{n , {n}^{′}} ≡ {δ}_{n , {n}^{′}} {\sum }_{m = 1}^{N} {K}_{n , m} & ( Equation 8 )\end{matrix}$$

(Equation 8) is differentiated using mapping matrix A to obtain (Equation 9). A matrix with a value of 0 on the right-hand side of (Equation 9) can be calculated as mapping matrix A.

$$\begin{matrix}Equation 9 & \\ 0 = \frac{\partial Φ ( A )}{\partial A} = {UGU}^{T} {A}^{T} - μ {UDU}^{T} {A}^{T} & ( Equation 9 )\end{matrix}$$

Returning to FIG. 2, the output display unit 204 calculates the corresponding points of each event sequence in two-dimensional space or three-dimensional space using the calculated mapping matrix A, and outputs and displays the calculated corresponding points in two-dimensional or three-dimensional space. More specifically, coordinate points z(p, q) are determined in map space for given event sequence x using mapping matrix A calculated from (Equation 9).

Equation 10

z=wA[wₙI_{M}+λL]⁻¹x (Equation 10)

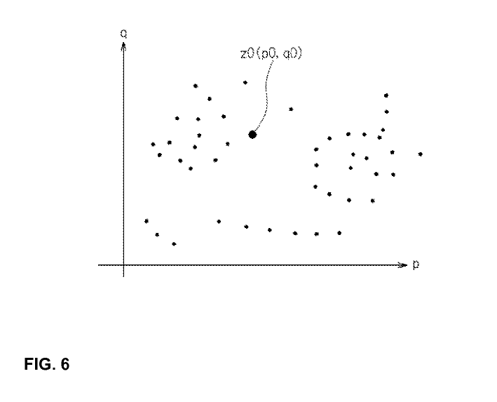

FIG. 6 is a diagram illustrating an example in which an acquired coordinate value z is outputted and displayed in two-dimensional space. In FIG. 6, the coordinate point is outputted and displayed in two-dimensional space consisting of axes p and q which are orthogonal to each other.

The coordinate point z0(p0, q0) outputted and displayed on plane pq using the mapping matrix A calculated from (Equation 9) is a risk assessment value. For example, in FIG. 6, coordinate points determined using the same mapping matrix A in all of the event sequences obtained as sampling data in which a critical event has occurred are outputted and displayed in the same two-dimensional space. Therefore, coordinate point z0(p0, q0) calculated on the basis of a given event sequence is outputted and displayed in a region densely populated with other coordinate points, or is outputted and displayed in a region sparsely populated with other coordinate points. In this way, the possibility of a critical event occurring can be determined visually using acquired event sequences.

It is often difficult to arrive at a decision from coarse-grained coordinate points and is difficult to determine anything visually simply by plotting risk assessment values in past event sequences. Therefore, the kernel density p(z) of coordinate value z is estimated on the basis of past event sequences.

Returning to FIG. 2, the kernel density estimating unit 205 runs likelihood cross-validation on past event sequences, and estimates the kernel density p(z) of the event sequences on which likelihood cross-validation has been run.

$$\begin{matrix}Equation 11 & \\ p ( z \vert β , {D}^{″} ) = {\sum }_{n = 1}^{N} {w}_{n} {H}_{β} ( z , {z}^{( n )} ) \\ However , \\ {H}_{β} ( z , {z}^{( n )} ) = c exp ( \frac{1}{2 {β}^{2}} {‖ z - {z}^{( n )} ‖}^{2} ) & ( Equation 11 )\end{matrix}$$

In (Equation 11), c is a constant meeting standardized conditions for kernel density p(z). For example, the value is set so that the integral value of kernel density p(z) is “1” in a predetermined domain of definition. Also, β represents the bandwidth, and is a constant calculated by running likelihood cross-validation.

When likelihood cross-validation is run, the event sequences acquired as sampling data are first split into several event sequences. For example, N event sequences are split into five, and a split event sequence group is set as D″(i) (i=a natural number from 1 to 5). The kernel density p(z) is calculated from (Equation 11) using the remaining four event sequence groups with respect to the bandwidth β of the one event sequence group D″(i), and the logarithmic likelihood Π(β) is calculated in accordance with (Equation 12).

$$\begin{matrix}Equation 12 & \\ Π ( β ) ≡ \frac{1}{5} {\sum }_{i = 1}^{5} {\sum }_{z ∈ {D}^{″} ( i )}^{ } ln p ( z \vert β , {D}^{″} \backslash {D}^{″} ( i ) ) & ( Equation 12 )\end{matrix}$$

From (Equation 12), the β with the largest logarithmic likelihood Π(β) is determined as the bandwidth β. In this embodiment, the event sequences were split into five. However, the present invention is not limited to this example. If there is a large enough amount of data, the event sequences can be split into a greater number than five.

The area output display unit 206 calculates the coordinate value z for two-dimensional space or three-dimensional space in all event sequences acquired as sampling data in which a critical event occurred, and determines whether or not risk has occurred on the basis of whether or not a label value indicating the occurrence of risk has been assigned to each calculated coordinate value z. Similarly, there is a high possibility of a critical event occurring in the vicinity of coordinate value z in a data set in which risk has occurred. Therefore, circumscribed areas for coordinate z are superimposed in two-dimensional space or three-dimensional space, outputted and displayed.

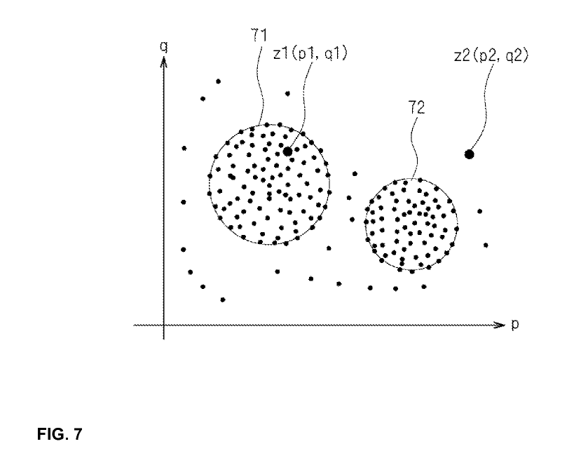

FIG. 7 is a diagram illustrating an example in which circumscribed areas are superimposed, outputted and displayed in two-dimensional space. In FIG. 7, the circumscribed areas are outputted and displayed in two-dimensional space consisting of axes p and q which are orthogonal to each other.

The coordinate points z1(p1,q1) and z2(p2, q2) outputted and displayed on plane pq using the mapping matrix A calculated from (Equation 9) are risk assessment values. For example, in FIG. 7, coordinate point z determined using the same mapping matrix A in all of the event sequences obtained as sampling data in which a critical event has occurred are outputted and displayed in the same two-dimensional space. Therefore, the circumscribed areas described above are calculated for the outputted and displayed coordinate values z, and regions 71 and 72 are superimposed, outputted and displayed.

Therefore, coordinate value z1 calculated in a given vector sequence can be visually determined to have a high probability of a critical event occurring because it is in circumscribed area 71. Similarly, coordinate value z2 calculated in a given vector sequence can be visually determined to have a low probability of a critical event occurring because it is not included in circumscribed area 72.

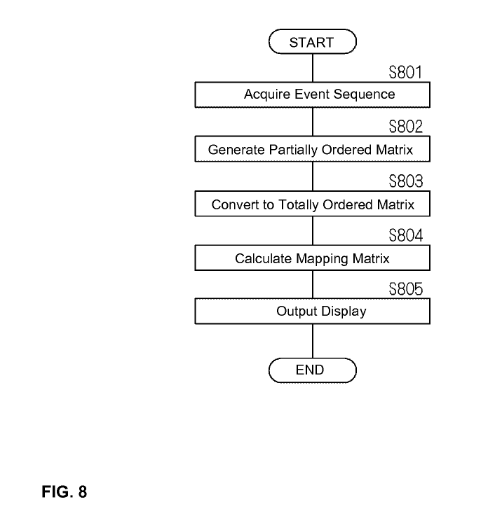

FIG. 8 is a flowchart showing the processing steps performed by the CPU 11 of the risk assessment value display device 1 in an embodiment of the present invention. The CPU 11 in the risk assessment value display device 1 acquires as sample data event sequences in the form of time series data for a plurality of events (Step S801). More specifically, a finite number N of event sequences (where N is a natural number), risk values for each event sequence, and the degree of similarity between elements included in each event sequence are acquired.

The CPU 11 generates partially ordered matrices (partially ordered sets) representing the order of events based on the acquired event sequences (Step S802), and converts the generated partially ordered matrices into an approximation of totally ordered matrices (totally ordered sets) (Step S803). In other words, because the partially ordered matrices generated on the basis of acquired event sequences are sparsely ordered matrices (so-called sparse matrices) in which most of the elements are “0”, they are converted to totally ordered matrices by interpolating the elements of sparse matrices whose values are “0”.

The CPU 11 calculates a mapping matrix for mapping on the basis of the totally ordered matrices the similarity relations between event sequences in two-dimensional or three-dimensional space using an embedding method (Step S804). More specifically, a mapping matrix is calculated as a matrix which minimizes an objective function able to maintain a similarity relation equally between event sequences even when the similarity relation between event sequences has been mapped in two-dimensional or three-dimensional space.

The CPU 11 calculates the corresponding points of each event sequence in two-dimensional space or three-dimensional space using the calculated mapping matrix, and outputs and displays the calculated corresponding points in two-dimensional or three-dimensional space (Step S805). More specifically, coordinate points z(p, q) are determined in map space for given event sequence x using mapping matrix A calculated from (Equation 9), and the coordinate point is outputted and displayed.

In the embodiment described above, risk assessment values can be calculated for each event sequence by converting partially ordered sets (matrices) indicating event sequences with different lengths and elements into totally ordered sets (matrices), and past cases can be easily compared by displaying and outputting the calculated risk assessment values in two-dimensional space or three-dimensional space. Also, the possibility (risk) of a critical event occurring can be visually evaluated in each event sequence by plotting and displaying or by performing a density conversion and then displaying the calculated risk assessment values in two-dimensional or three-dimensional space.

Another embodiment of the present invention is the method in the first aspect of the invention, in which the mapping matrix is calculated as a matrix minimizing an objective function able to maintain a similarity relation equally between event sequences even when the similarity relation between event sequences has been mapped in two-dimensional or three-dimensional space.

Another embodiment of the present invention includes a step for running likelihood cross-validation on the event sequences and for estimating the kernel density of the event sequences on which likelihood cross-validation has been run.

embodiment of the present invention, in which the method also includes a step for calculating the corresponding points in two-dimensional space or three-dimensional space for all event sequences, for determining whether or not the kernel density is greater than a predetermined value at each calculated corresponding point, and for superimposing and outputting for display a circumscribed area of corresponding points exceeding the predetermined value.

Another embodiment of the present invention includes the mapping matrix calculating means calculates the mapping matrix as a matrix minimizing an objective function able to maintain a similarity relation equally between event sequences even when the similarity relation between event sequences has been mapped in two-dimensional or three-dimensional space.

Another embodiment of the present invention includes a kernel density estimating means for running likelihood cross-validation on the event sequences, and for estimating the kernel density of the event sequences on which likelihood cross-validation has been run.

Another embodiment of the present invention includes an area display output means for calculating the corresponding points in two-dimensional space or three-dimensional space for all event sequences, and for superimposing and outputting for display in two-dimensional space or three-dimensional space circumscribed areas of corresponding points labeled as to whether or not a risk has occurred at each calculated corresponding point.

The embodiment described above can be applied effectively to medical event sequences. For example, there is a wide range of symptoms such as having a headache, having a stomachache and feeling sick, and it is difficult to determine whether or not a series of symptoms is a sign of a serious illness. Therefore, it is conceivable that the risk of suffering from serious illnesses can be reduced by acquiring event sequences such as interview data with many patients and data on everyday life as sampling data, and applying the sampling data to a model to predict the risk of suffering from a serious illness such as diabetes or cancer.

In the present invention, risk assessment values can be calculated for each event sequence by converting partially ordered sets (matrices) indicating event sequences with different lengths and elements into totally ordered sets (matrices), and past cases can be easily compared by displaying and outputting the calculated risk assessment values in two-dimensional space or three-dimensional space. Also, the possibility (risk) of a critical event occurring can be visually evaluated in each event sequence by plotting and displaying or by performing a density conversion and then displaying the calculated risk assessment values in two-dimensional or three-dimensional space.

The present invention is not limited to the embodiment described above, and various modifications and improvements are possible within the scope of the present invention. In other words, the present invention is not limited to the medical event sequences described in the embodiment. Needless to say, it can be applied to any event in which there is a cause and effect.

1. A method for calculating and displaying a plurality of risk assessment values for an event sequence, wherein the event sequence comprises a plurality of events for a finite number M of types (where M is a natural number) and a portion of the event group being a partially ordered set in a time series, the method comprising:
generating an M-dimensional sparsely ordered matrix based on the event sequence, and interpolating between a plurality of elements of the M-dimensional sparsely ordered matrix to calculate a densely ordered matrix;
calculating a mapping matrix for mapping a plurality of similarity relations between a plurality of event sequences in two-dimensional space or three-dimensional space based on the densely ordered matrix;
calculating the plurality of corresponding points of each event sequence in two-dimensional space or three-dimensional space using the mapping matrix; and
outputting and displaying the plurality of corresponding points in two-dimensional or three-dimensional space.

2. The method of claim 1, wherein the mapping matrix is calculated as a matrix minimizing an objective function which is able to maintain a similarity relation equally between the plurality of event sequences while the similarity relation between the plurality of event sequences has been mapped in two-dimensional or three-dimensional space.

3. The method of claim 1, further comprising:
running a likelihood cross-validation on the plurality of event sequences; and
estimating a kernel density of the plurality of event sequences on which the likelihood cross-validation has been run.

4. The method of claim 3, further comprises:
calculating the plurality of corresponding points in two-dimensional space or three-dimensional space for the plurality of event sequences;
determining whether the kernel density is greater than a predetermined value at each corresponding point; and
superimposing and outputting a circumscribed area of the plurality of corresponding points exceeding the predetermined value for display.

5. A device for calculating and displaying a plurality of risk assessment values for an event sequence, wherein the event sequence comprises a plurality of events for a finite number M of types (where M is a natural number) and a portion of the event group being a partially ordered set in a time series, the device comprising:
an order matrix calculating means for generating an M-dimensional sparsely ordered matrix on the basis of the event sequence, and interpolating between a plurality of elements of the M-dimensional sparsely ordered matrix to calculate a densely ordered matrix;
a mapping matrix calculating means for calculating a mapping matrix for mapping a plurality of similarity relations between a plurality of event sequences in two-dimensional space or three-dimensional space based on the densely ordered matrix; and
a display output means for calculating a plurality of corresponding points of each event sequence in two-dimensional space or three-dimensional space using the mapping matrix; and
outputting and displaying the plurality of corresponding points in two-dimensional or three-dimensional space.

6. The device of claim 5, wherein the mapping matrix calculating means calculates the mapping matrix as a matrix minimizing an objective function which is able to maintain a similarity relation which is equal between the plurality of event sequences while the similarity relation between the plurality of event sequences has been mapped in two-dimensional or three-dimensional space.

7. The device of claim 5, wherein a kernel density means comprises:
running a likelihood cross-validation on the plurality of event sequences; and
estimating the kernel density of the plurality of event sequences on which the likelihood cross-validation has been run.

8. The method of claim 7, wherein an area display output means comprises:
calculating the plurality of corresponding points in two-dimensional space or three-dimensional space for the plurality of event sequences; and
superimposing and outputting in two-dimensional space or three-dimensional space a plurality of circumscribed areas of the plurality of corresponding points labeled as to whether a risk has occurred at each calculated corresponding point for display.

9. A computer readable non-transitory article of manufacture tangibly embodying computer readable instructions which, when executed, cause a computer to carry out the steps of a method for calculating and displaying a plurality of risk assessment values for an event sequence, wherein the event sequence comprises a plurality of events for a finite number M of types (where M is a natural number) and a portion of the event group being a partially ordered set in a time series, the method comprising:
generating an M-dimensional sparsely ordered matrix on the basis of the event sequence, and interpolating between a plurality of elements of the M-dimensional sparsely ordered matrix to calculate a densely ordered matrix;
calculating a mapping matrix for mapping a plurality of similarity relations between a plurality of event sequences in two-dimensional space or three-dimensional space based on the densely ordered matrix;
calculating the plurality of corresponding points of each event sequence in two-dimensional space or three-dimensional space using the mapping matrix; and
outputting and displaying the plurality of corresponding points in two-dimensional or three-dimensional space.

10. The computer program of claim 9, wherein the mapping matrix is calculated as a matrix minimizing an objective function which is able to maintain a similarity relation equally between the plurality of event sequences while the similarity relation between the plurality of event sequences has been mapped in two-dimensional or three-dimensional space.

11. The computer program of claim 9, further comprising:
running a likelihood cross-validation on the plurality of event sequences; and
estimating the kernel density of the plurality of event sequences on which the likelihood cross-validation has been run.

12. The computer program of claim 11, further comprising:
calculating the plurality of corresponding points in two-dimensional space or three-dimensional space for the plurality event sequences; and
superimposing and outputting in two-dimensional space or three-dimensional space a plurality of circumscribed areas of corresponding points labeled as to whether a risk has occurred at each calculated corresponding point for display.
